(19) United States
(12) Patent Application Publication
(10) Pub. No.: US 2019/0093754 A1
(43) Pub. Date: Mar. 28, 2019

(54) OIL GUIDE MEMBER

(71) Applicants: AISIN AI CO., LTD., Nishio-shi (JP); TOYOTA JIDOSHA KABUSHIKI KAISHA, Toyota-shi (JP)

(72) Inventors: Maito Heki, Okayama-shi (JP); Junichi Kato, Toyota-shi (JP); Yoshichika Shimane, Toyota-shi (JP)

(73) Assignees: AISIN AI CO., LTD., Nishio-shi (JP); TOYOTA JIDOSHA KABUSHIKI KAISHA, Toyota-shi (JP)

(21) Appl. No.: 16/142,470

(22) Filed: Sep. 26, 2018

(30) Foreign Application Priority Data
Sep. 27, 2017 (JP) 2017-187180
Jul. 18, 2018 (JP) 2018-135245

(51) Int. Cl. F16H 57/04

(52) U.S. Cl. CPC F16H 57/0426; F16H 57/0423; F16H 2200/0052; F16H 57/043; F16H 57/0471; F16H 57/0424

(57) ABSTRACT

According to one embodiment, an oil guide member is provided in a case of, for example, a transmission. The case is provided with a first oil channel through which lubricant flows when a shaft is rotated in a first rotation direction, and a second oil channel through which the lubricant flows when the shaft is rotated in a second rotation direction. The oil guide member includes a base portion forming an oil chamber capable of storing the lubricant between the base portion and an internal surface of the case, and an extending portion extending from the base portion toward inside of an internal oil channel of the shaft, and provided with a communicating channel communicating with the oil chamber and the internal oil channel. The base portion is provided with an inlet allowing an inflow of the lubricant from the first oil channel and the lubricant from the second oil channel.

### CROSS-REFERENCE TO RELATED APPLICATIONS

This application is based upon and claims the benefit of priority from Japanese Patent Application No. 2017-187180, filed Sep. 27 2017 and Japanese Patent Application No. 2018-135245, filed Jul. 18, 2018, the entire contents of which are incorporated herein by reference.

### FIELD

Embodiments described herein relate generally to an oil guide member.

### BACKGROUND

In prior art, an oil guide member is known. The oil guide member is provided in a case of a transmission mounted on a vehicle to guide lubricant combed up with gears in the case into a shaft of the transmission (for example, see Japanese Patent Application Laid-open No. 2014-173658).

### SUMMARY

In the transmission, there are cases where a gear combing up the lubricant is provided on a shaft in which a rotation direction in the case of moving the vehicle forward is opposite to the rotation direction in the case of moving the vehicle backward. In this case, a profitable structure is a structure capable of guiding the lubricant into the shaft regardless of the rotation direction of the shaft.

For this reason, an object of the present invention is, for example, to acquire an oil guide member capable of supplying lubricant into the shaft regardless of the rotation direction of the shaft.

According to one embodiment, an oil guide member is provided in a case of, for example, a transmission. The transmission includes a shaft selectively rotated in a first rotation direction and a second rotation direction opposite to the first rotation direction, provided with an internal oil channel provided inside the shaft and allowing an inflow of lubricant, and including an end portion to which the internal oil channel is opened; and the case containing the shaft and storing the lubricant therein, the case being provided therein with a first oil channel through which the lubricant flows when the shaft is rotated in the first rotation direction, and a second oil channel through which the lubricant flows when the shaft is rotated in the second rotation direction. The oil guide member comprises: a base portion provided between the end portion of the shaft and an internal surface of the case, supported with the case, and forming an oil chamber capable of storing the lubricant between the base portion and the internal surface; and an extending portion extending from the base portion toward inside of the internal oil channel, and provided with a communicating channel communicating with the oil chamber and the internal oil channel, wherein the base portion is provided with an inlet allowing an inflow of the lubricant from the first oil channel and the lubricant from the second oil channel.

With this structure, when the shaft is rotated in the first rotation direction, for example, the lubricant flows out of the first oil channel to the inlet of the oil guide member, and reaches the oil chamber. The lubricant in the oil chamber runs through the communicating channel, and flows to the internal space of the shaft. By contrast, when the shaft is rotated in the second rotation direction, for example, the lubricant flows out of the second oil channel to the inlet of the oil guide member, and reaches the oil chamber. The lubricant in the oil chamber runs through the communicating channel, and flows to the internal space of the shaft. Accordingly, the present invention provides an oil guide member capable of supplying lubricant into the shaft regardless of the rotation direction of the shaft.

In the oil guide member, for example, the inlet includes a first opening portion into which the lubricant flows from the first oil channel, and a second opening portion into which the lubricant flows from the second oil channel, and the base portion includes a partition portion partitioning a space between the first opening portion and the second opening portion.

Because the base portion includes the partition portion, this structure improves the strength and the stiffness of the oil guide member, in comparison with the structure in which the base portion includes no partition portion and the inlet is formed of one opening portion.

In the oil guide member, for example, the partition portion is positioned in the case.

Because the partition portion is positioned in the case, this structure improves the assembly of the oil guide member and easiness to increase the positioning accuracy of the oil guide member, in comparison with the structure in which the partition portion is not positioned in the case.

In the oil guide member, for example, a lower end of the inlet is positioned higher than a lower end of the communicating channel in a vertical direction of the transmission.

This structure easily suppresses an outflow of the lubricant stored in the oil chamber from the inlet to the outside of the oil chamber.

### BRIEF DESCRIPTION OF THE DRAWINGS

FIG. 1 is an exemplary and schematic block diagram of a vehicle according to an embodiment;

FIG. 2 is an exemplary and schematic diagram illustrating an arrangement of a plurality of shafts as viewed in an axial direction of a transmission according to the embodiment;

FIG. 3 is an exemplary and schematic cross-sectional view of part of inside of the transmission according to the embodiment;

FIG. 4 is an exemplary and schematic cross-sectional view illustrating part of inside of the transmission according to the embodiment, and illustrating a cross section different from FIG. 3;

FIG. 5 is an arrow view with an arrow V of FIG. 4;

FIG. 6 is an exemplary and schematic perspective view of an oil guide member according to the embodiment;

FIG. 7 is an exemplary and schematic front view of the oil guide member according to the embodiment;

FIG. 8 is a cross-sectional view taken along line VIII-VIII of FIG. 5; and

FIG. 9 is a cross-sectional view taken along line IX-IX of FIG. 5.

### DETAILED DESCRIPTION

The following is a disclosure of an exemplary embodiment of the present invention. The configuration of the embodiment described hereinafter, and functions and effects produced by the configuration, are examples. In the present specification, the ordinal numbers are used to distinguish components and/or parts from each other, and do not indicate the order or priority.

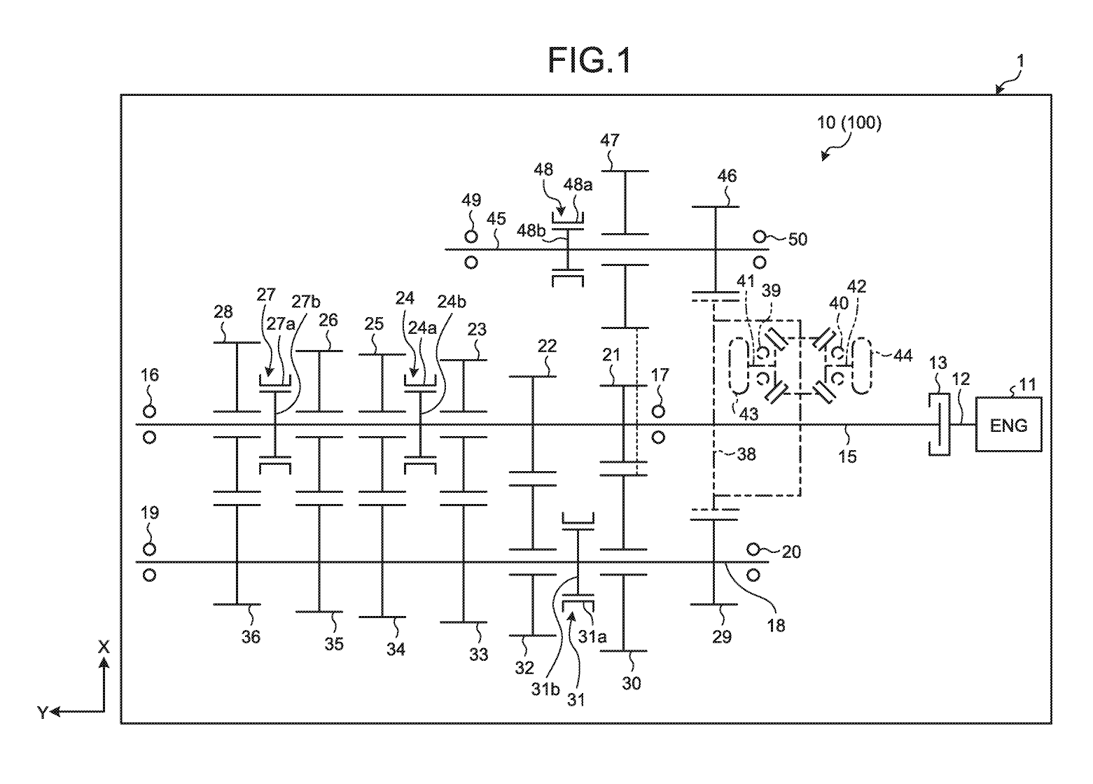

FIG. 1 is an exemplary and schematic block diagram of a vehicle 1. As illustrated in FIG. 1, the vehicle 1 includes an engine (ENG) 11, a transmission 100, wheels 43 and 44 serving as driving wheels, and wheels (not illustrated) serving as coupled driving wheels. In the following explanation, three directions orthogonal to each other are defined. An X direction extends along the forward and backward direction of the vehicle 1 on which the transmission 100 is mounted, a Y direction extends along the vehicle width direction, and a Z direction extends along the vertical direction (perpendicular direction). The vertical direction in the following explanation is the vertical direction of the vehicle 1 and the transmission 100.

The transmission 100 is provided between the engine 11 serving as the input side and the wheels 43 and 44 serving as the output side. The transmission 100 is capable of regulating the motive power (torque) of the engine 11 by an operation of a shift lever (not illustrated) in accordance with the traveling circumstances, and transmitting the motive power to the wheels 43 and 44. The transmission 100 is, for example, in a state of being coupled with the engine 11 and supported by a vehicle body (not illustrated).

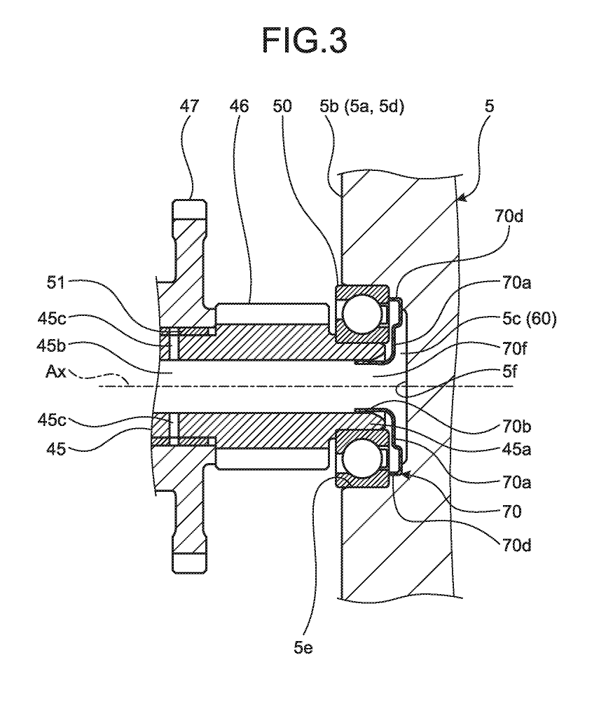

The transmission 100 includes, for example, a case 5 (see FIG. 3), a transmission mechanism 10, and a clutch 13. The transmission mechanism 10 and the clutch 13 are contained in the case 5. Lubricant is stored in a lower part of the case 5. The transmission mechanism 10 includes, for example, six transmission gear stages (first speed gear to sixth speed gear) for forward movement of the vehicle 1, and a transmission gear stage (reverse) for backward movement of the vehicle 1. The case 5 is also referred to as a transmission case.

The transmission mechanism 10 includes a first shaft 15, a second shaft 18, and a third shaft 45, as a plurality of shafts. The first shaft 15 is rotatably supported with the case 5 via bearings 16 and 17. The second shaft 18 is rotatably supported with the case 5 via bearings 19 and 20, and the third shaft 45 is rotatably supported with the case 5 via bearings 49 and 50. The third shaft 45 serves as an example of the shaft. The first shaft 15 is also referred to as an input shaft, and the second shaft 18 and the third shaft 45 are also referred to as output shafts.

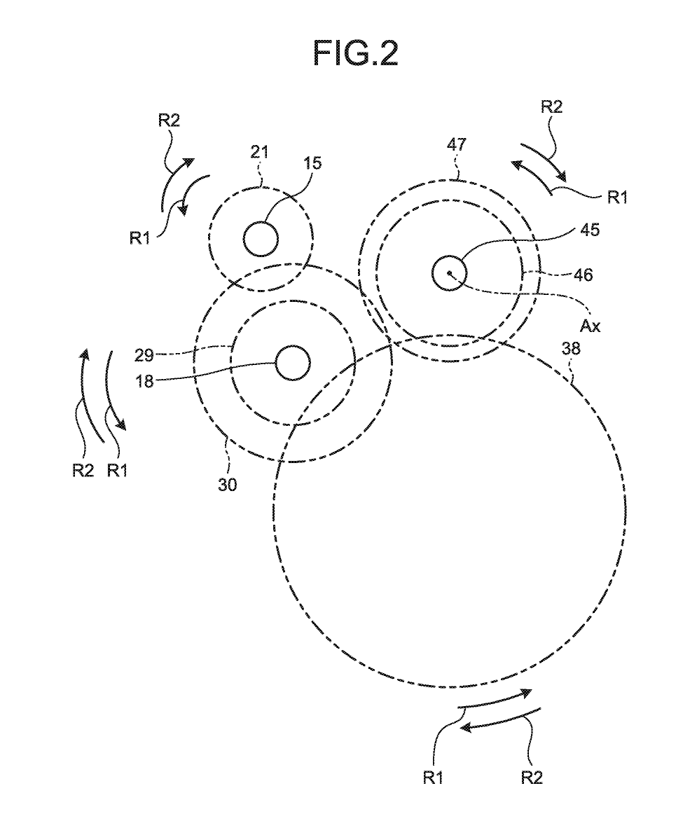

FIG. 2 is an exemplary and schematic diagram illustrating an arrangement of the shafts as viewed in the axial direction of the transmission 100. As illustrated in FIGS. 1 and 2, the second shaft 18 and the third shaft 45 are arranged in parallel with the first shaft 15, and with a space around the first shaft 15. In the present embodiment, for example, the first shaft 15 and the third shaft 45 are arranged apart from each other in the horizontal direction in FIG. 2, and the second shaft 18 is disposed between the first shaft 15 and the third shaft 45, and at a position lower than the first shaft 15 and the third shaft 45 in FIG. 2. However, the present invention is not limited to such arrangement of the first to the third shafts 15, 18, and 45.

As illustrated in FIG. 1, the first shaft 15 is connected with an output shaft 12 of the engine 11 through the clutch 13. The clutch 13 switches the connected state with the disconnected state of the engine 11 and the first shaft 15. The second shaft 18 and the third shaft 45 are connected with drive shafts 41 and 42 of the wheels 43 and 44 through a differential case 38. The drive shafts 41 and 42 are rotatably supported with the vehicle body via bearings 39 and 40.

In addition, a plurality of driving gears 21, 22, 23, 25, 26, and 28 are provided between the bearing 16 and the bearing 17 of the first shaft 15. In the present embodiment, for example, the driving gear 21 of the first transmission gear stage, the driving gear 22 of the second transmission gear stage, the driving gear 23 of the third transmission gear stage, the driving gear 25 of the fourth transmission gear stage, the driving gear 26 of the fifth transmission gear stage, and the driving gear 28 of the sixth transmission gear stage are arranged from the engine 11 side in the Y direction.

The driving gears 21 and 22 are provided rotatably as one unitary piece with the first shaft 15, and the driving gears 23, 25, 26, and 28 are provided relatively rotatably with respect to the first shaft 15. The driving gears 21 and 22 are united with the first shaft 15 by, for example, spline connection or press fitting. The driving gears 23, 25, 26, and 28 are supported with the first shaft 15 via bearings or the like such that they are relatively rotatable with respect to the first shaft 15. The driving gears 23, 25, 26, and 28 are capable of idling with respect to the first shaft 15, in the state where they are not connected with the first shaft 15 with first selection mechanisms 24 and 27 illustrated in FIG. 1.

In addition, a plurality of driven gears 30 and 32 to 36, and a final gear 29 are provided between the bearing 19 and the bearing 20 of the second shaft 18. In the present embodiment, for example, the final gear 29, the driven gear 30 of the first transmission gear stage, the driven gear 32 of the second transmission gear stage, the driven gear 33 of the third transmission gear stage, the driven gear 34 of the fourth transmission gear stage, the driven gear 35 of the fifth transmission gear stage, and the driven gear 36 of the sixth transmission gear stage are arranged from the engine 11 side in the Y direction. The driven gears 30 and 32 to 36 are engaged with the respective corresponding driving gears 21, 22, 23, 25, 26, and 28. The final gear 29 is engaged with the differential case 38.

The driven gears 30 and 32 are provided relatively rotatably with respect to the second shaft 18, and the driven gears 33 to 36 and the final gear 29 are provided rotatably as one unitary piece with the second shaft 18. The driven gears 30 and 32 are capable of idling with respect to the second shaft 18, in the state where the driven gears 30 and 32 are not connected with the second shaft 18 with a second selection mechanism 31 illustrated in FIG. 1.

The second selection mechanism 31 selectively switches the connected state and the disconnected state of the second shaft 18 and the driven gears 30 and 32. The second selection mechanism 31 includes a sleeve 31a and a clutch hub 31b. The clutch hub 31b is coupled with the second shaft 18 by, for example, spline connection, and rotated as one unitary piece with the second shaft 18. The sleeve 31a is rotated as one unitary piece with the clutch hub 31b, and movable in the axial direction (Y direction) of the second shaft 18 with respect to the clutch hub 31b.

The second selection mechanism 31 is disposed between the driven gear 30 and the driven gear 32, and the sleeve 31a is configured to be movable between a first coupling position at which the sleeve 31a is coupled with the driven gear 30, a second coupling position at which the sleeve 31a is coupled with the driven gear 32, and a neutral position between the first coupling position and the second coupling position. With an actuator and a moving mechanism (not illustrated), the sleeve 31a is selectively positioned at one of the first coupling position to be coupled with the driven gear 30, the second coupling position to be coupled with the driven gear 32, and the neutral position. In a state where the sleeve 31a is positioned at the first coupling position to be coupled with the driven gear 30, the second shaft 18 and the driven gear 30 are rotatable as one unitary piece. In this case, a transmission path of rotation of the first transmission gear stage is formed. The transmission path ranges from the first shaft 15, the driving gear 21, the driven gear 30, the second shaft 18, the final gear 29, the differential case 38, to the drive shafts 41 and 42 as illustrated in FIG. 1.

When the transmission path of rotation of the first transmission gear stage is formed, for example, the first shaft 15, the driving gear 21, and the differential case 38 are rotated in a counterclockwise direction (hereinafter referred to as regular direction R1) in FIG. 2, and the driven gear 30, the second shaft 18, and the final gear 29 are rotated in a clockwise direction (hereinafter referred to as reverse direction R2). The regular direction R1 is an example of the second rotation direction, and the reverse direction R2 is an example of the first rotation direction.

In addition, when the sleeve 31a is positioned at the second coupling position to be coupled with the driven gear 32, the second shaft 18 and the driven gear 32 are rotatable as one unitary piece. In this case, a transmission path of rotation of the second transmission gear stage is formed. The transmission path ranges from the first shaft 15, the driving gear 22, the driven gear 32, the second shaft 18, the final gear 29, the differential case 38, to the drive shafts 41 and 42 illustrated in FIG. 1. In the state where the sleeve 31a is positioned at the neutral position and in the state where the sleeve 31a is positioned at a position to be coupled with other driven gears, the driven gears 30 and 32 are capable of idling with respect to the second shaft 18.

When the transmission path of rotation of the second transmission gear stage is formed, for example, the first shaft 15, the driving gear 22, and the differential case 38 are rotated in the regular direction R1 (FIG. 2), and the driven gear 32, the second shaft 18, and the final gear 29 are rotated in the reverse direction R2 (FIG. 2).

The first selection mechanisms 24 and 27 selectively switch the connected state with the disconnected state of the first shaft 15 and the driving gears 23, 25, 26, and 28. The first selection mechanisms 24 and 27 include sleeves 24a and 27a, and clutch hubs 24b and 27b, respectively.

The first selection mechanism 24 is disposed between the driving gear 23 and the driving gear 25, and the sleeve 24a is configured to be movable between a first coupling position at which the sleeve 24a is coupled with the driving gear 23, a second coupling position at which the sleeve 24a is coupled with the driving gear 25, and a neutral position between the first coupling position and the second coupling position. With an actuator and a moving mechanism (not illustrated), the sleeve 24a is selectively positioned at one of the first coupling position to be coupled with the driving gear 23, the second coupling position to be coupled with the driving gear 25, and the neutral position. In a state where the sleeve 24a is positioned at the first coupling position to be coupled with the driving gear 23, the first shaft 15 and the driving gear 23 are rotatable as one unitary piece. In this case, a transmission path of rotation of the third transmission gear stage is formed. The transmission path ranges from the first shaft 15, the driving gear 23, the driven gear 33, the second shaft 18, the final gear 29, the differential case 38, to the drive shafts 41 and 42 as illustrated in FIG. 1.

When the transmission path of rotation of the third transmission gear stage is formed, for example, the first shaft 15, the driving gear 23, and the differential case 38 are rotated in the regular direction R1 (FIG. 2), and the driven gear 33, the second shaft 18, and the final gear 29 are rotated in the reverse direction R2 (FIG. 2).

In addition, when the sleeve 24a is positioned at the second coupling position to be coupled with the driving gear 25, the first shaft 15 and the driving gear 25 are rotatable as one unitary piece. In this case, a transmission path of rotation of the fourth transmission gear stage is formed. The transmission path ranges from the first shaft 15, the driving gear 25, the driven gear 34, the second shaft 18, the final gear 29, the differential case 38, to the drive shafts 41 and 42 illustrated in FIG. 1.

When the transmission path of rotation of the fourth transmission gear stage is formed, for example, the first shaft 15, the driving gear 25, and the differential case 38 are rotated in the regular direction R1 (FIG. 2), and the driven gear 34, the second shaft 18, and the final gear 29 are rotated in the reverse direction R2 (FIG. 2).

The first selection mechanism 27 is disposed between the driving gear 26 and the driving gear 28, and the sleeve 27a is configured to be movable between a first coupling position at which the sleeve 27a is coupled with the driving gear 26, a second coupling position at which the sleeve 27a is coupled with the driving gear 28, and a neutral position between the first coupling position and the second coupling position. With an actuator and a moving mechanism (not illustrated), the sleeve 27a is selectively positioned at one of the first coupling position to be coupled with the driving gear 26, the second coupling position to be coupled with the driving gear 28, and the neutral position. In a state where the sleeve 27a is positioned at the first coupling position to be coupled with the driving gear 26, the first shaft 15 and the driving gear 26 are rotatable as one unitary piece. In this case, a transmission path of rotation of the fifth transmission gear stage is formed. The transmission path ranges from the first shaft 15, the driving gear 26, the driven gear 35, the second shaft 18, the final gear 29, the differential case 38, to the drive shafts 41 and 42 as illustrated in FIG. 1.

When the transmission path of rotation of the fifth transmission gear stage is formed, for example, the first shaft 15, the driving gear 26, and the differential case 38 are rotated in the regular direction R1 (FIG. 2), and the driven gear 35, the second shaft 18, and the final gear 29 are rotated in the reverse direction R2 (FIG. 2).

In addition, when the sleeve 27a is positioned at the second coupling position to be coupled with the driving gear 28, the first shaft 15 and the driving gear 28 are rotatable as one unitary piece. In this case, a transmission path of rotation of the sixth transmission gear stage is formed. The transmission path ranges from the first shaft 15, the driving gear 28, the driven gear 36, the second shaft 18, the final gear 29, the differential case 38, to the drive shafts 41 and 42 illustrated in FIG. 1.

When the transmission path of rotation of the sixth transmission gear stage is formed, for example, the first shaft 15, the driving gear 28, and the differential case 38 are rotated in the regular direction R1 (FIG. 2), and the driven gear 36, the second shaft 18, and the final gear 29 are rotated in the reverse direction R2 (FIG. 2).

In addition, an idler gear 47 and a final gear 46 are provided between the bearing 49 and the bearing 50 of the third shaft 45. In the present embodiment, for example, the final gear 46 and the idler gear 47 of the reverse transmission gear stage are arranged from the engine 11 side in the Y direction. The final gear 46 is engaged with the differential case 38, and the idler gear 47 is engaged with the driven gear 30.

The final gear 46 is provided rotatably as one unitary piece with the third shaft 45, and the idler gear 47 is provided relatively rotatably with respect to the third shaft 45. The idler gear 47 is capable of idling with respect to the third shaft 45, in the state where the idler gear is not connected with the third shaft 45 with a third selection mechanism 48 illustrated in FIG. 1.

The third selection mechanism 48 selectively switches the connected state with the disconnected state of the third shaft 45 and the idler gear 47. The third selection mechanism 48 includes a sleeve 48a and a clutch hub 48b.

As illustrated in FIG. 1, the third selection mechanism 48 is disposed between the bearing 49 and the idler gear 47, and the sleeve 48a is configured to be movable between a coupling position at which the sleeve 48a is coupled with the idler gear 47, and a separated position at which the sleeve 48a is separated from the idler gear 47. With an actuator and a moving mechanism (not illustrated), the sleeve 48a is selectively positioned at one of the coupling position to be coupled with the idler gear 47 and the separated position. In a state where the sleeve 48a is positioned at the coupling position to be coupled with the idler gear 47, the third shaft 45 and the idler gear 47 are rotatable as one unitary piece. In this case, a transmission path of rotation of the reverse transmission gear stage is formed. The transmission path ranges from the first shaft 15, the driving gear 21, the driven gear 30, the third shaft 45, the final gear 46, the differential case 38, to the drive shafts 41 and 42 as illustrated in FIG. 1. The position of the third selection mechanism 48 is not limited to the position described above, and has no influence on the functions or effects of the present invention.

When the transmission path of rotation of the reverse transmission gear stage is formed, for example, the first shaft 15, the driving gear 21, the idler gear 47, the third shaft 45, and the final gear 46 are rotated in the regular direction R1, and the driven gear 30 and the differential case 38 are rotated in the reverse direction R2. In addition, because the differential case 38 and the final gear 29 are engaged with each other, the final gear 29 and the second shaft 18 are rotated in the regular direction R1.

In addition, when the transmission paths of the transmission gear stages (first to sixth transmission gear stages) of forward movement described above are formed, as described above, the first shaft 15 and the differential case 38 are rotated in the regular direction R1, and the second shaft 18 and the final gear 29 are rotated in the reverse direction R2. In this case, because the differential case 38 and the final gear 46 are engaged with each other, the final gear 46 and the third shaft 45 are rotated in the reverse direction R2 (FIG. 2). In the present embodiment, the regular direction R1 is an example of the second rotation direction, and the reverse direction R2 is an example of the first rotation direction.

As is clear from above, in the present embodiment, the first shaft 15 is rotated in the regular direction R1, and the second shaft 18 and the third shaft 45 are selectively rotated in the regular direction R1 and the reverse direction R2.

In the transmission 100 with the structure described above, the lubricant stored in the case 5 is combed up with the various gears (the driving gears 21, 22, 23, 25, 26, and 28 and the driven gears 30 and 32 to 36), and supplied to each of parts of the transmission mechanism 10.

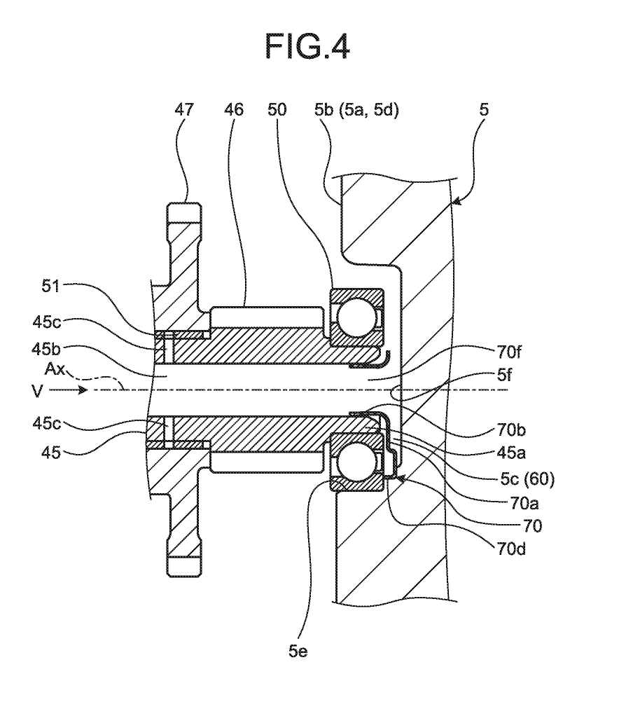

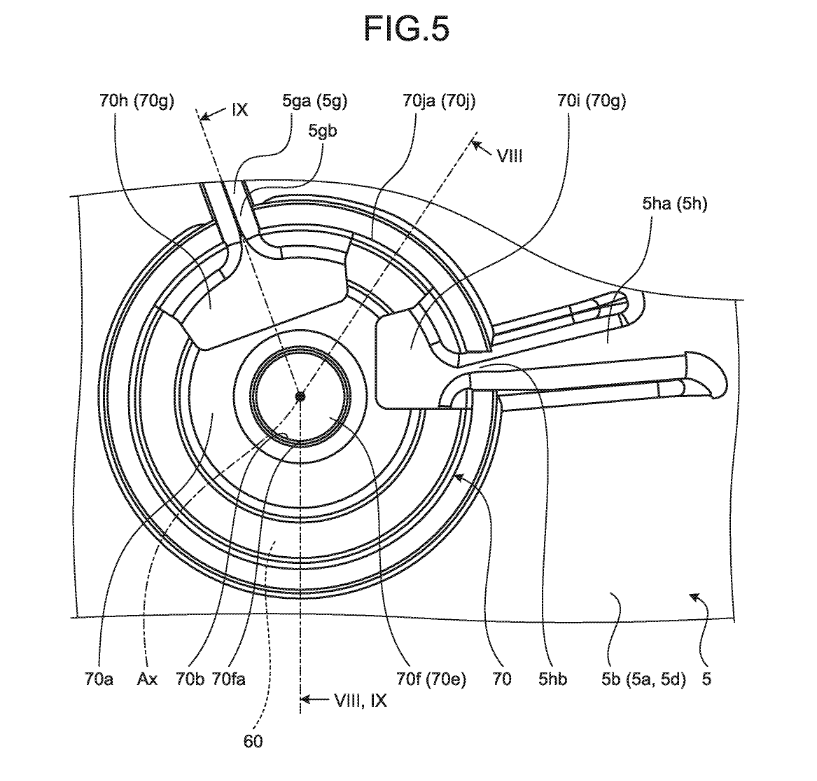

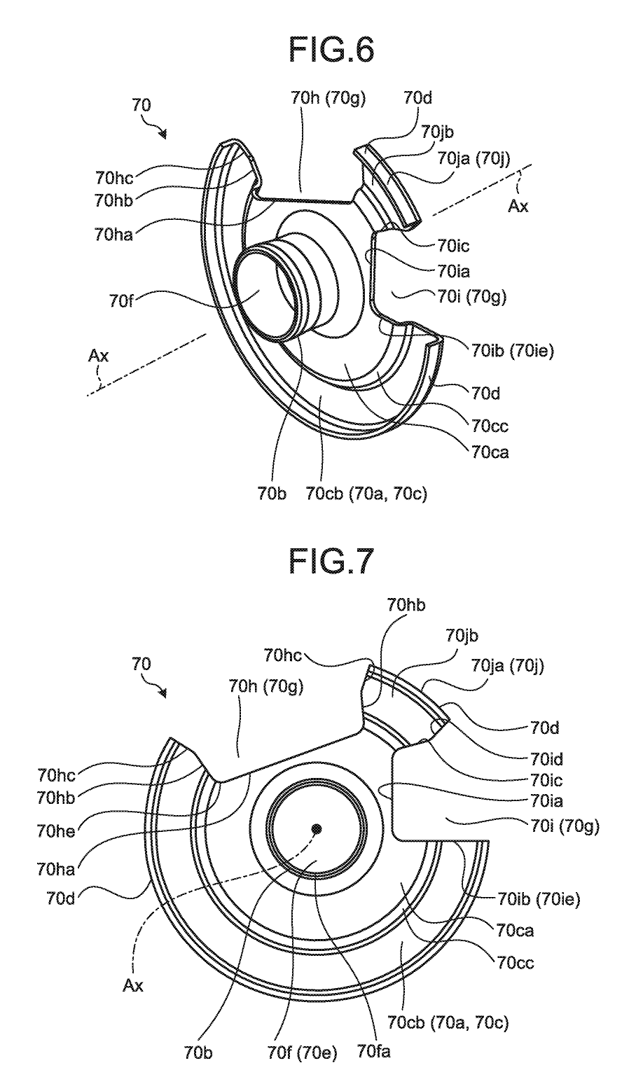

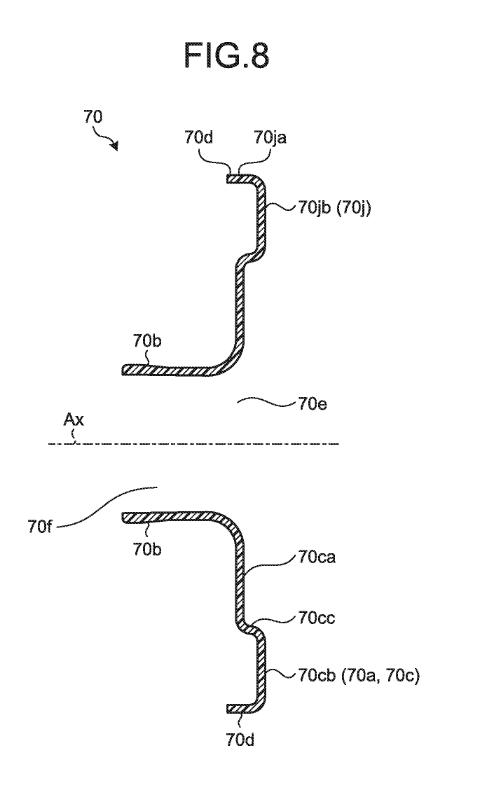

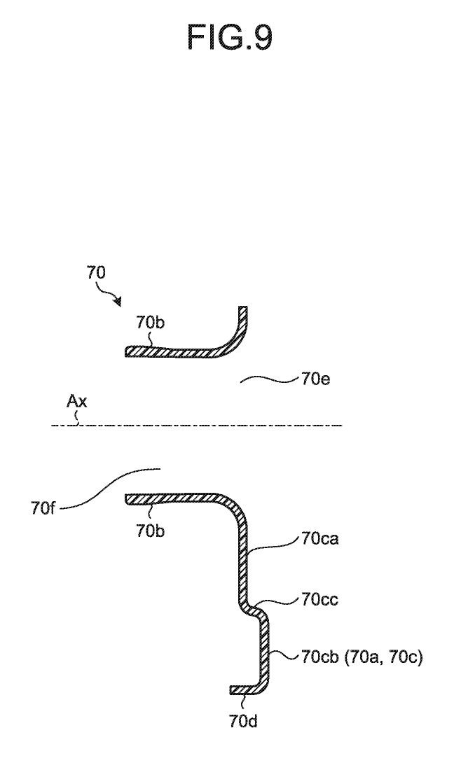

The following is an explanation of a lubricant supplying structure supplying lubricant to parts of the transmission 100 including the third shaft 45, with reference to FIG. 3 to FIG. 9. FIG. 3 is an exemplary and schematic cross-sectional view of part of inside of the transmission 100. FIG. 4 is an exemplary and schematic cross-sectional view of part of inside of the transmission 100, and illustrating a cross section different from FIG. 3. FIG. 5 is an arrow view with an arrow V of FIG. 4. FIG. 6 is an exemplary and schematic perspective view of an oil guide member 70. FIG. 7 is an exemplary and schematic front view of the oil guide member 70. FIG. 8 is a cross-sectional view taken along line VIII-VIII of FIG. 5. FIG. 9 is a cross-sectional view taken along line IX-IX of FIG. 5. In FIG. 3, the third selection mechanism 48 is not illustrated, because it is located in a part omitted in FIG. 3. FIG. 5 omits illustration of the idler gear 47 and the like.

In the following explanation, as long as not particularly referred to, the axial direction is the axial direction of the rotation center Ax (FIG. 2) of the third shaft 45, the radial direction is the radial direction of the rotation center Ax of the third shaft 45, and the circumferential direction is the circumferential direction of the rotation center Ax of the third shaft 45. The rotation center Ax is also referred to as the central axis.

As illustrated in FIG. 3 and FIG. 4, an internal surface 5b of a wall portion 5a of the case 5 is provided with a recessed portion 5c. The recessed portion 5c is recessed from a surface 5d forming the internal surface 5b and extending in a direction crossing the axial direction toward the external surface (not illustrated: the right side in FIG. 3) of the wall portion 5a, along the axial direction. The recessed portion 5c is surrounded with a cylindrical surface 5e and a bottom surface 5f forming the internal surface 5b. The cylindrical surface 5e is formed in a cylindrical surface shape around the rotation center Ax, and extends from the surface 5d toward the external surface of the wall portion 5a. The bottom surface 5f is formed in a circular shape extending in the radial direction, and connects with an end portion of the cylindrical surface 5e opposite to the surface 5d. The bottom surface 5f and the cylindrical surface 5e are also referred to as surfaces.

The recessed portion 5c receives the bearing 50 and one axial end portion 45a of the third shaft 45. The outer ring of the bearing 50 is supported with the cylindrical surface 5e, in the state of being inserted into the cylindrical surface 5e.

In addition, as illustrated in FIG. 5, a forward movement oil channel 5g and a backward movement oil channel 5h serving as oil channels are provided in the case 5. The lubricant combed up with the gears flows through the forward movement oil channel 5g, when the third shaft 45 is rotated in the reverse direction R2 (the first rotation direction), that is, when the transmission gear stage of the transmission 100 is set to forward movement. The lubricant combed up with the gears flows through the backward movement oil channel 5h, when the third shaft 45 is rotated in the regular direction R1 (the second rotation direction), that is, when the transmission gear stage of the transmission 100 is set to backward movement. The forward movement oil channel 5g and the backward movement oil channel 5h are independent separate paths. The forward movement oil channel 5g is an example of the first oil channel, and the backward movement oil channel 5h is an example of the second oil channel.

The forward movement oil channel 5g includes a groove portion 5ga formed in the surface 5d. The groove portion 5ga includes an outlet 5gb of the forward movement oil channel 5g. The groove portion 5ga extends in a direction crossing the axial direction. The outlet 5gb is opened to the rotation center Ax (third shaft 45), as viewed in the axial direction (FIG. 5). Specifically, the groove portion 5ga is inclined with respect to the vertical direction, formed to go downward as it extends toward the outlet 5gb, and brought close to an inlet 70g of the oil guide member 70 described later. The groove portion 5ga is an example of an inclined portion.

The backward movement oil channel 5h includes a groove portion 5ha formed in the surface 5d. The groove portion 5ha includes an outlet 5hb of the backward movement oil channel 5h. The groove portion 5ha extends in a direction crossing the axial direction and the groove portion 5ga. The outlet 5hb is opened to the rotation center Ax (third shaft 45), as viewed in the axial direction. Specifically, the groove portion 5ha is inclined with respect to the vertical direction, formed to go downward as it extends toward the outlet 5hb, and brought close to the inlet 70g of the oil guide member 70. The groove portion 5ha is an example of an inclined portion.

As illustrated in FIG. 3 and FIG. 4, the third shaft 45 is provided with an internal oil channel 45b and a plurality of oil supplying channels 45c. The internal oil channel 45b is provided inside the third shaft 45, and extends along the axial direction from the end portion 45a of the third shaft 45. The internal oil channel 45b is opened to the end portion 45a.

The oil supplying channels 45c pierce the external circumferential surface and the internal circumferential surface of the third shaft 45 in the radial direction. Specifically, each of the oil supplying channels 45c is formed of a through hole piercing the third shaft 45, and communicates with the internal oil channel 45b. The oil supplying channels 45c face a bearing 51 rotatably supporting the idler gear 47.

As illustrated in FIG. 3 and FIG. 4, the oil guide member 70 is contained in the recessed portion 5c, in a state of being positioned between the wall portion 5a and the third shaft 45, in the case 5. As illustrated in FIG. 6 to FIG. 9, the oil guide member 70 includes a base portion 70a and an extending portion 70b extending from the base portion 70a.

The base portion 70a includes a wall portion 70c and an attachment portion 70d. The wall portion 70c spreads in the radial direction. The wall portion 70c is provided with an opening portion 70e piercing the wall portion 70c in the axial direction of the rotation center Ax. The wall portion 70c includes a first portion 70ca provided on the internal circumferential side in the wall portion 70c, a second portion 70cb provided on the external circumferential side in the wall portion 70c, and a connecting portion 70cc connecting the first portion 70ca with the second portion 70cb.

Each of the first portion 70ca and the second portion 70cb is formed in a plate shape spreading in the radial direction. The first portion 70ca and the second portion 70cb are positioned to be shifted from each other in the axial direction. Specifically, the second portion 70cb is closer to the surface 5d than the first portion ca. The connecting portion 70cc is interposed between the external circumferential portion of the first portion 70ca and the internal circumferential portion of the second portion 70cb. The connecting portion 70cc forms a difference in level between the first portion 70ca and the second portion 70cb. The connecting portion 70cc is aimed at improving the stiffness of the base portion 70a, and consequently, the oil guide member 70.

The attachment portion 70d extends from an external circumferential portion of the second portion 70cb, that is, the external circumferential end portion of the base portion 70a in the axial direction of the rotation center Ax. Specifically, the attachment portion 70d extends from the base portion 70a in a direction opposite to the surface 5d.

As illustrated in FIG. 3, the base portion 70a is supported with the cylindrical portion 5e of the wall portion 5a, in the state where the base portion 70a is positioned between the end portion 45a and the internal surface 5b of the wall portion 5a. Specifically, the attachment portion 70d is attached to the cylindrical surface 5e with a hook mechanism or the like. This structure limits rotation of the base portion 70a, and consequently, the oil guide member 70 around the rotation center Ax. The base portion 70a forms an oil chamber 60 capable of storing lubricant between itself and the bottom surface 5f (internal surface 5b).

As illustrated in FIG. 6 to FIG. 9, the extending portion 70b is formed in a cylindrical shape around the rotation center Ax. The extending portion 70b extends from the internal circumferential portion of the first portion 70ca of the base portion 70a toward the inside of the internal oil channel 45b of the third shaft 45. Specifically, the extending portion 70b extends from the base portion 70a in a direction opposite to the bottom surface 5f. The extending portion 70b is positioned in the third shaft 45. A communicating channel 70f is provided inside the extending portion 70b. The communicating channel 70f extends through the extending portion 70b in the axial direction, communicates with the opening portion 70e of the base portion 70a, and communicates with the oil chamber 60 and the internal oil channel 45b.

As illustrated in FIG. 5 to FIG. 7, the base portion 70a is provided with the inlet 70g receiving the lubricant. Specifically, the inlet 70g allows an inflow of the lubricant. The inlet 70g includes a forward movement opening portion 70h and a backward movement opening portion 70i, as a plurality of opening portions. The forward movement opening portion 70h allows an inflow of lubricant flowing out of the outlet 5gb of the forward movement oil channel 5g. Specifically, the lubricant from the forward movement oil channel 5g flows into the forward movement opening portion 70h. The backward movement opening portion 70i allows an inflow of lubricant flowing out of the outlet 5hb of the backward movement oil channel 5h. Specifically, the lubricant from the backward movement oil channel 5h flows into the backward movement opening portion 70i. A partition portion 70j partitions a space between the forward movement opening portion 70h and the backward movement opening portion 70i. The forward movement opening portion 70h is an example of the first opening portion, and the backward movement opening portion 70i is an example of the second opening portion.

The forward movement opening portion 70h extends from the external circumferential portion of the base portion 70a toward the internal circumferential portion of the base portion 70a. The forward movement opening portion 70h is a cutaway portion provided to extend over the wall portion 70c of the base portion 70a and the attachment portion 70d. The forward movement opening portion 70h is positioned above the communicating channel 70f, as viewed in the axial direction (FIGS. 5 and 7).

As illustrated in FIG. 7, the forward movement opening portion 70h includes a first edge portion 70ha, a pair of second edge portions 70hb, and a pair of third edge portions 70hc. The first edge portion 70ha extends in an inclined state with respect to the horizontal direction. The second edge portions 70hb extend from both end portions of the first edge portion 70ha toward the external circumferential portion of the base portion 70a. The second edge portions 70hb are positioned with a space between each other in the circumferential direction. The second edge portions 70hb are inclined such that the space therebetween is broadened toward the outside in the radial direction, that is, toward the external circumferential edge portion of the base portion 70a. The third edge portions 70hc extend from respective end portions of the respective second edge portions 70hb opposite to the first edge portion 70ha toward the external circumferential portion of the base portion 70a. The third edge portions 70hc are positioned with a space between each other in the circumferential direction. The third edge portions 70hc are inclined such that the space therebetween is broadened toward the outside in the radial direction, that is, toward the external circumferential portion of the base portion 70a. The third edge portions 70hc are inclined with respect to the respective second edge portions 70hb such that the space between the third edge portions 70hc is broader than the space between the second edge portions 70hb as viewed in the axial direction. A lower end 70he of the forward movement opening portion 70h is formed of a connecting portion between a lower end of the first edge portion 70ha and a lower end of one second edge portion 70hb.

The backward movement opening portion 70i extends from the external circumferential portion of the base portion 70a toward the internal circumferential portion of the base portion 70a. The backward movement opening portion 70i is a cutaway portion provided to extend over the wall portion 70c of the base portion 70a and the attachment portion 70d. The backward movement opening portion 70i is positioned on a side of the communicating channel 70f, as viewed in the axial direction (FIGS. 5 and 7).

The backward movement opening portion 70i includes a first edge portion 70ia, a second edge portion 70ib, a third edge portion 70ic, and a fourth edge portion 70id. The first edge portion 70ia extends along the vertical direction. The second edge portion 70ib extends from a lower end portion of the first edge portion 70ia toward the external circumferential portion of the base portion 70a.

Specifically, the second edge portion 70ib extends in the horizontal direction. The second edge portion 70ib forms a lower end 70ie of the backward movement opening portion 70i. The lower end 70ie also serves as the lower end of the inlet 70g. The lower end 70ie is positioned higher than a lower end 70fa of the communicating channel 70f. The third edge portion 70ic extends from an upper end portion of the first edge portion 70ia toward the external circumferential portion of the base portion 70a. The third edge portion 70ic is positioned with a space from the second edge portion 70ib in the circumferential direction. The space in the circumferential direction between the third edge portion 70ic and the second edge portion 70ib is broadened toward the outside in the radial direction, that is, toward the external circumferential portion of the base portion 70a. The fourth edge portion 70id extends from an end portion of the third edge portion 70ic opposite to the first edge portion 70ia toward the outside in the radial direction, that is, toward the external circumferential portion of the base portion 70a. The fourth edge portion 70id is inclined with respect to the third edge portion 70ic such that the space between the fourth edge portion 70id and the second edge portion 70ib is broader than the space between the third edge portion 70ic and the second edge portion 70ib as viewed in the axial direction.

As illustrated in FIG. 7, the partition portion 70j is positioned between the forward movement opening portion 70h and the backward movement opening portion 70i. The partition portion 70j faces the other second edge portion 70hb and the third edge portion 70hc of the forward movement opening portion 70h, and the third edge portion 70ic and the fourth edge portion 70id of the backward movement opening portion 70i. Specifically, the partition portion 70j includes a widened portion 70jb in which the width in the circumferential direction increases toward the outside in the radial direction. An end portion 70ja of the partition portion 70j located outside in the radial direction is positioned in the wall portion 5a. Specifically, the end portion 70ja of the partition portion 70j is in the state of contacting the cylindrical surface 5e, and limited in movement in the radial direction of the rotation center Ax with the cylindrical surface 5e.

With this structure, when the transmission mechanism 10 is set to the forward movement transmission gear stage (first speed gear to sixth speed gear), the lubricant stored in the case 5 is combed up with the gears (the driving gears 21, 22, 23, 25, 26, and 28, and the driven gears 30 and 32 to 36), and supplied to the parts of the transmission mechanism 10. In this case, the lubricant flows through the forward movement oil channel 5g (FIG. 5), and the lubricant flowing out of the outlet 5gb of the forward movement oil channel 5g flows into the forward movement opening portion 70h of the oil guide member 70, and is stored in the oil chamber 60. When the liquid level of the lubricant in the oil chamber 60 increases to be higher than the lower end 70fa of the communicating channel 70f, the lubricant flows from the oil chamber 60 to the communicating channel 70f, and flows into the internal oil channel 45b of the third shaft 45. The lubricant having flowed into the internal oil channel 45b runs through the oil supplying channels 45c, and reaches the bearing 51. Specifically, the lubricant is supplied to the bearing 51. The bearing 51 is an example of the supply target.

By contrast, when the transmission mechanism 10 is set to the backward movement transmission gear stage (reverse), the lubricant stored in the case 5 is combed up with the gears (the driving gears 21, 22, 23, 25, 26, and 28, and the driven gears 30 and 32 to 36), and supplied to the parts of the transmission mechanism 10. In this case, the lubricant flows through the backward movement oil channel 5h, and the lubricant flowing out of the outlet 5hb of the backward movement oil channel 5h flows into the backward movement opening portion 70i of the oil guide member 70, and is stored in the oil chamber 60. In the same manner as the case where the transmission mechanism 10 is set to the forward movement transmission gear stage (first speed gear to sixth speed gear), the lubricant stored in the oil chamber 60 runs through the communicating channel 70f, the internal oil channel 45b, and the oil supplying channels 45c, and reaches the bearing 51. Specifically, the lubricant is supplied to the bearing 51.

As described above, in the present embodiment, the base portion 70a of the oil guide member 70 is provided with the inlet 70g allowing an inflow of the lubricant from the forward movement oil channel 5g and an inflow of the lubricant from the backward movement oil channel 5h. This structure enables supply of lubricant into the third shaft 45 regardless of the rotation direction of the third shaft 45 (shaft).

In addition, in the present embodiment, the inlet 70g includes the forward movement opening portion 70h (first opening portion) into which the lubricant from the forward movement oil channel 5g flows, and the backward movement opening portion 70i (second opening portion) into which the lubricant from the backward movement oil channel 5h flows. The base portion 70a also includes the partition portion 70j partitioning the space between the forward movement opening portion 70h and the backward movement opening portion 70i. Because the base portion 70a includes the partition portion 70j, this structure improves the strength and the stiffness of the oil guide member 70 in comparison with the structure in which the base portion 70a includes no partition portion 70j and the inlet 70g is formed of one opening portion.

In the present embodiment, the partition portion 70j is positioned in the case 5. This structure improves the assembly of the oil guide member 70 and easiness to increase the positioning accuracy of the oil guide member 70 in comparison with the structure in which the partition portion 70j is not positioned in the case 5.

In the present embodiment, the lower end 70ie of the backward movement opening portion 70i serving as the lower end of the inlet 70g is positioned higher than the lower end 70fa of the communicating channel 70f. This structure easily suppresses an outflow of the lubricant stored in the oil chamber 60 from the inlet 70g to the outside of the oil chamber 60.

In the present embodiment, at least one (both as an example) of the forward movement oil channel 5g serving as the supplying channel (oil channel) and the backward movement oil channel 5h serving as the supplying channel (oil channel) includes the outlet 5gb or 5hb, and the groove portion 5ga or 5ha (inclined portion) inclined with respect to the vertical direction, formed to go downward in the vertical direction as it extends toward the outlet 5gb or 5hb, and is brought close to the inlet 70g. This structure easily increases the degree of freedom of arrangement of the forward movement oil channel 5g and the backward movement oil channel 5h, in comparison with the structure in which both the forward movement oil channel 5g and the backward movement oil channel 5h are provided along the vertical direction.

In the present embodiment, the lower end 70ie of the backward movement opening portion 70i serving as the lower end of the inlet 70g is positioned higher than the lower end 70fa of the communicating channel 70f. In addition, the second edge portion 70ib of the backward movement opening portion 70i, that is, the lower end 70ie extends in the horizontal direction. This structure suppresses increase in opening area of the backward movement opening portion 70i and an outflow of the lubricant from the backward movement opening portion 70i.

The present embodiment illustrates the example in which the inlet 70g includes the forward movement opening portion 70h and the backward movement opening portion 70i, but the structure is not limited thereto. For example, the inlet 70g may include one opening portion into which the lubricant from the forward movement oil channel 5g and the lubricant from the backward movement oil channel 5h flow. In other words, the structure may include no partition portion 70j.

In addition, the present embodiment illustrates the example in which each of the forward movement opening portion 70h and the backward movement opening portion 70i are formed by a cutaway portion, but the structure is not limited thereto. For example, the forward movement opening portion 70h and the backward movement opening portion 70i may be formed of a through hole piercing the base portion 70a.

In addition, the present embodiment illustrates the example in which the oil guide member 70 is provided on the third shaft 45, but the structure is not limited thereto. For example, the oil guide member 70 may be provided on the second shaft 18.

The following is disclosure of additional remarks.

At least one supplying channels of the first oil channel and the second oil channel serving as supplying channels includes an outlet and an inclined part inclined with respect to the vertical direction of the transmission, going downward in the vertical direction as it extends toward the outlet, and brought close to the inlet.

The lower end of the second opening portion is positioned higher than the lower end of the internal oil channel and extends in the horizontal direction.

While the certain embodiment has been described above, the embodiment has been presented by way of example only, and is not intended to limit the scope of the inventions. The embodiment described above may be embodied in a variety of other forms; furthermore, various omissions, substitutions and changes may be made without departing from the gist of the inventions. The embodiment described above is included in the scope and the gist of the invention, and included in the inventions described in the claims and a range equivalent thereto. The present invention can be achieved with structures other than the structure disclosed in the embodiment described above, and can acquire various effects (including derivative effects) acquired with the basic structure (technical features) thereof. The specs (such as the structure, the type, the direction, the shape, the size, the length, the width, the thickness, the height, the number, the arrangement, the position, and the material) of each of the constituent elements may be properly changed and carried out.

What is claimed is:

1. An oil guide member provided in a case of a transmission, the transmission including:
a shaft selectively rotated in a first rotation direction and a second rotation direction opposite to the first rotation direction, provided with an internal oil channel provided inside the shaft and allowing an inflow of lubricant, and including an end portion to which the internal oil channel is opened; and
the case containing the shaft and storing the lubricant therein, the case being provided therein with a first oil channel through which the lubricant flows when the shaft is rotated in the first rotation direction, and a second oil channel through which the lubricant flows when the shaft is rotated in the second rotation direction,
the oil guide member comprising:
a base portion provided between the end portion of the shaft and an internal surface of the case, supported with the case, and forming an oil chamber capable of storing the lubricant between the base portion and the internal surface; and
an extending portion extending from the base portion toward inside of the internal oil channel, and provided with a communicating channel communicating with the oil chamber and the internal oil channel, wherein
the base portion is provided with an inlet allowing an inflow of the lubricant from the first oil channel and the lubricant from the second oil channel.

2. The oil guide member according to claim 1, wherein
the inlet includes a first opening portion into which the lubricant flows from the first oil channel, and a second opening portion into which the lubricant flows from the second oil channel, and
the base portion includes a partition portion partitioning a space between the first opening portion and the second opening portion.

3. The oil guide member according to claim 2, wherein the partition portion is positioned in the case.

4. The oil guide member according to claim 1, wherein a lower end of the inlet is positioned higher than a lower end of the communicating channel in a vertical direction of the transmission.
